(19) United States
(12) Patent Application Publication
(10) Pub. No.: US 2013/0322535 A1
(43) Pub. Date: Dec. 5, 2013

(54) METHOD FOR ENCODING AND DECODING IMAGES USING PLURALITY OF REFERENCE IMAGES AND DEVICE USING METHOD

(71) Applicants: Sung Chang Lim, Daejeon (KR); Hui Yong Kim, Daejeon-si (KR); Se Yoon Jeong, Daejeon-si (KR); Suk Hee Cho, Daejeon-si (KR); Jong Ho Kim, Daejeon-si (KR); Ha Hyun Lee, Seoul (KR); Jin Ho Lee, Daejeon-si (KR); Jin Soo Choi, Daejeon-si (KR); Jin Woong Kim, Daejeon-si (KR); Hae Chul Choi, Daejeon-si (KR)

(72) Inventors: Sung Chang Lim, Daejeon (KR); Hui Yong Kim, Daejeon-si (KR); Se Yoon Jeong, Daejeon-si (KR); Suk Hee Cho, Daejeon-si (KR); Jong Ho Kim, Daejeon-si (KR); Ha Hyun Lee, Seoul (KR); Jin Ho Lee, Daejeon-si (KR); Jin Soo Choi, Daejeon-si (KR); Jin Woong Kim, Daejeon-si (KR); Hae Chul Choi, Daejeon-si (KR)

(73) Assignee: ELECTRONICS AND TELECOMMUNICATIONS RESEARCH INSTITUTE, Daejeon-si (KR)

(21) Appl. No.: 14/000,437

(22) PCT Filed: Feb. 21, 2012
(86) PCT No.: PCT/KR2012/001311

§ 371 Date: Aug. 20, 2013

(30) Foreign Application Priority Data
Feb. 21, 2011 (KR) 10-2011-0015231
Feb. 21, 2012 (KR) 10-2012-0017429

(51) Int. Cl. H04N 7/36

(52) U.S. Cl. CPC H04N 19/00575
USPC 375/240.15; 375/240.12; 375/240.16

(57) ABSTRACT

Disclosed are a method for encoding and decoding images using a plurality of reference images and a device using the method. The decoding method comprises the steps of: decoding predictive direction information; and decoding reference picture index information on the basis of said predictive direction information. Thus, the invention can increase an encoding efficiency by reducing the number of reference picture indexes.

### TECHNICAL FIELD

The present invention relates to a method of encoding/decoding an image, and more particularly, to a method of encoding/decoding an image using a plurality of reference pictures and an apparatus using the same.

### BACKGROUND ART

Recently, in accordance with the expansion of broadcasting services having high definition (HD) resolution in the country and around the world, many users have been accustomed to a high resolution and definition image, such that many organizations have attempted to develop the next-generation image devices. In addition, as the interest in HDTV and ultra high definition (UHD) having a resolution four times higher than that of HDTV have increased, a compression technology for a higher-resolution and higher-definition image has been demanded.

For the image compression, an inter prediction technology of predicting pixel values included in a present picture from a picture before and/or after the present picture, an intra prediction technology of predicting pixel values included in a present picture using pixel information in the present picture, an entropy encoding technology of allocating a short code to symbols having a high appearance frequency and a long code to symbols having a low appearance frequency, or the like, may be used.

An example of the image compression technology may include a technology providing a predetermined network bandwidth under a limited operation environment of hardware, without considering a flexible network environment. However, in order to compress image data applied to the network environment in which the bandwidth is frequently changed, a new compression technology is required. To this end, a scalable video encoding/decoding method may be used.

### DISCLOSURE

### Technical Problem

The present invention provides a method of indicating reference picture index information in inter prediction.

The present invention also provides an apparatus of performing a method of indicating reference picture index information in inter prediction.

### Technical Solution

In an aspect, there is provided a method of decoding an image, the method including: decoding prediction direction information; and decoding reference picture index information based on the prediction direction information. The prediction direction information may include a first prediction direction in which a prediction target block is predicted based on at least one of pictures present in a reverse direction of a prediction target picture and at least one of pictures present in a forward direction of the prediction target picture, a second direction in which the prediction target block is predicted based on ones of the pictures present in the forward direction of the prediction target picture, and a third direction in which the prediction target block is predicted based on ones of the pictures present in the reverse direction of the prediction target picture. The prediction direction information may further include a fourth direction in which the prediction target block is predicted based on one of the pictures present in the forward direction of the prediction target picture and a fifth direction in which the prediction target block is predicted based on one of the pictures present in the reverse direction of the prediction target picture. The decoding of the reference picture index information based on the prediction direction information may include decoding at least one picture index in a forward direction of a prediction target picture and decoding at least one picture index in a reverse direction of the prediction target picture in the case in which a prediction target block is a first direction, decoding a plurality of picture indices in the forward direction of the prediction target picture in the case in which the prediction target block is a second direction, and decoding a plurality of picture indices in the reverse direction of the prediction target picture in the case in which the prediction target block is a third direction. The decoding of the reference picture index information based on the prediction direction information may further include decoding one picture index in the forward direction of the prediction target picture in the case in which the prediction target block is a fourth direction and decoding one picture index in the reverse direction of the prediction target picture in the case in which the prediction target block is a fifth direction. The method may further include decoding motion vector information. The prediction direction information may be information encoded as syntax element information.

In another aspect, there is provided an apparatus of decoding an image, the apparatus including: a prediction direction information determining unit prediction direction information; and a reference picture determining unit determining index information of a picture predicted based on the prediction direction information. The prediction direction information may include a first prediction direction in which a prediction target block is predicted based on at least one of pictures present in a reverse direction of a prediction target picture and at least one of pictures present in a forward direction of the prediction target picture, a second direction in which the prediction target block is predicted based on ones of the pictures present in the forward direction of the prediction target picture, and a third direction in which the prediction target block is predicted based on ones of the pictures present in the reverse direction of the prediction target picture. The prediction direction information may further include a fourth direction in which the prediction target block is predicted based on one of the pictures present in the forward direction of the prediction target picture and a fifth direction in which the prediction target block is predicted based on one of the pictures present in the reverse direction of the prediction target picture. The decoding of the reference picture index information based on the prediction direction information may include decoding at least one picture index in a forward direction of a prediction target picture and decoding at least one picture index in a reverse direction of the prediction target picture in the case in which a prediction target block is a first direction, decoding a plurality of picture indices in the forward direction of the prediction target picture in the case in which the prediction target block is a second direction, and decoding a plurality of picture indices in the reverse direction of the prediction target picture in the case in which the prediction target block is a third direction. The decoding of the reference picture index information based on the prediction direction information may further include decoding one picture index in the forward direction of the prediction target picture in the case in which the prediction target block is a fourth direction and decoding one picture index in the reverse direction of the prediction target picture in the case in which the prediction target block is a fifth direction. The method may further include a prediction performing unit decoding motion vector information to perform prediction.

### Advantageous Effects

A method of encoding/decoding an image using a plurality of reference pictures and the apparatus using the same according to exemplary embodiments of the present invention may improve encoding efficiency in encoding reference picture index information by encoding/decoding reference picture information used in inter prediction.

### DESCRIPTION OF DRAWINGS

FIG. 1 is a block diagram showing an apparatus of encoding an image according to an exemplary embodiment of the present invention.

FIG. 2 is a block diagram showing a configuration of an apparatus of decoding an image according to an exemplary embodiment of the present invention.

FIG. 3 is a flow chart showing a method of encoding an image using a plurality of reference pictures according to an exemplary embodiment of the present invention.

FIG. 4 is a conceptual diagram showing a method of selecting and encoding a reference picture index according to an exemplary embodiment of the present invention.

FIG. 5 is a flow chart showing a method of decoding an image using a plurality of reference pictures according to an exemplary embodiment of the present invention.

FIG. 6 is a flow chart showing a method of encoding an image using a plurality of reference pictures according to an exemplary embodiment of the present invention.

FIG. 7 is a flow chart showing a method of decoding an image using a plurality of reference pictures according to an exemplary embodiment of the present invention.

FIG. 8 is a conceptual diagram showing a portion of an apparatus of encoding an image according to an exemplary embodiment of the present invention.

FIG. 9 is a conceptual diagram showing a portion of an apparatus of decoding an image according to an exemplary embodiment of the present invention.

### MODE FOR INVENTION

Since the present invention may be variously modified and have several exemplary embodiments, specific exemplary embodiments will be shown in the accompanying drawings and be described in detail in a detailed description. However, it is to be understood that the present invention is not limited to the specific exemplary embodiments, but includes all modifications, equivalents, and substitutions included in the spirit and the scope of the present invention. Throughout the accompanying drawings, the same reference numerals will be used to describe the same components.

Terms used in the specification, ‘first’, ‘second’, etc. can be used to describe various components, but the components are not to be construed as being limited to the terms. The terms are only used to differentiate one component from other components. For example, the ‘first’ component may be named the ‘second’ component and the ‘second’ component may also be similarly named the ‘first’ component, without departing from the scope of the present invention. A term ‘and/or’ includes a combination of a plurality of related described items or any one of the plurality of related described items.

It is to be understood that when one element is referred to as being “connected to” or “coupled to” another element, it may be connected directly to or coupled directly to another element or be connected to or coupled to another element, having the other element intervening therebetween. On the other hand, it is to be understood that when one element is referred to as being “connected directly to” or “coupled directly to” another element, it may be connected to or coupled to another element without the other element intervening therebetween.

Terms used in the present specification are used only in order to describe specific exemplary embodiments rather than limiting the present invention. Singular forms are intended to include plural forms unless the context clearly indicates otherwise. It will be further understood that the terms “comprises” or “have” used in this specification, specify the presence of stated features, steps, operations, components, parts, or a combination thereof, but do not preclude the presence or addition of one or more other features, numerals, steps, operations, components, parts, or a combination thereof.

Hereinafter, exemplary embodiments of the present invention will be described in more detail with reference to the accompanying drawings. Hereinafter, the same reference numerals will be used to describe the same components throughout the accompanying drawings, and an overlapped description of the same components will be omitted.

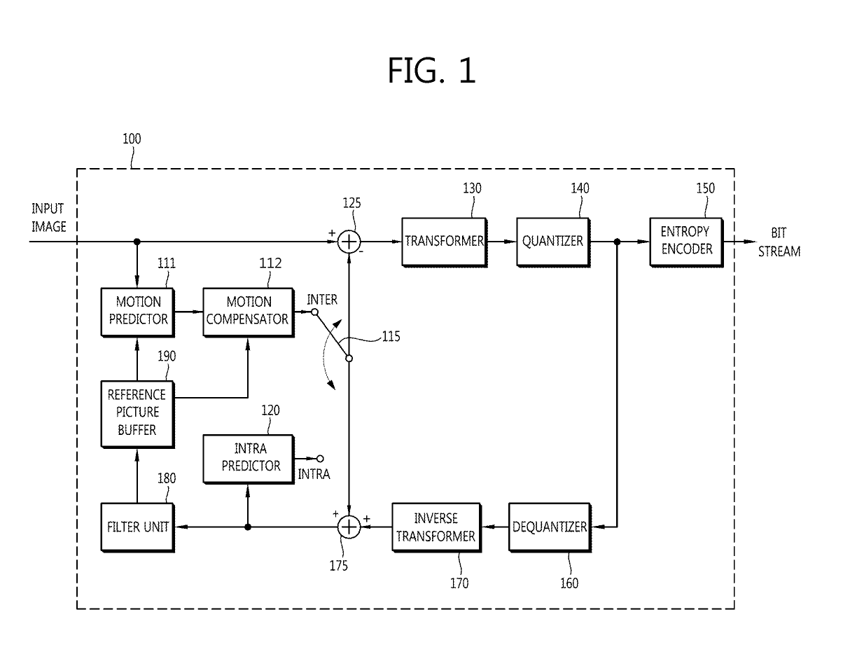

FIG. 1 is a block diagram showing an apparatus of encoding an image according to an exemplary embodiment of the present invention.

Referring to FIG. 1, an apparatus 100 of encoding an image includes a motion predictor 111, a motion compensator 112, an intra predictor 120, a switch 115, a subtractor 125, a transformer 130, a quantizer 140, an entropy encoder 150, a dequantizer 160, an inverse transformer 170, an adder 175, a filter unit 180, and a reference picture buffer 190.

The apparatus 100 of encoding an image performs encoding on an input image in an intra-mode or an inter-mode and outputs bit streams. Hereinafter, in an exemplary embodiment of the present invention, intra prediction may be used as the same meaning as intra prediction, and inter prediction may be used as the same meaning as inter prediction. In order to determined an optimal prediction method for a prediction unit, an intra prediction method and an inter prediction method may be selectively used for the prediction unit. The apparatus 100 of encoding an image generates a prediction block for an original block of the input image and then encodes a difference between the original block and the prediction block.

In the case of an intra prediction mode, the intra predictor 120 (or an intra predictor that may be used as a term having the same meaning as that of the intra predictor 120) performs spatial prediction using pixel values of previously encoded blocks adjacent to a current block to generate a prediction block.

In an inter prediction mode, the motion predictor 111 searches a region optimally matched with the input block in a reference picture stored in the reference picture buffer 190 during a motion prediction process to obtain a motion vector. The motion compensator 112 performs motion compensation using the motion vector to generate the prediction block.

The subtractor 125 generates a residual block by a difference between the input block and the generated prediction block. The transformer 130 performs transform on the residual block to output a transform coefficient. Further, the quantizer 140 quantizes the input transform coefficient according to a quantization parameter to output a quantized coefficient. The entropy encoding unit 150 entropy-encodes the input quantized coefficient according to probability distribution to output the bit stream.

When the entropy encoding is applied, symbols are represented by allocating a small number of bits to symbols having high generation probability and allocating a large number of bits to symbols having low generation probability, thereby making it possible to reduce a size of bit streams for the encoding target symbols. Therefore, the compression performance of the image encoding may be improved through the entropy encoding. The entropy encoder 150 may use an encoding method such as exponential golomb, context-adaptive variable length coding (CAVLC), context-adaptive binary arithmetic coding (CABAC), or the like, for the entropy encoding.

Since inter prediction encoding, that is, inter prediction encoding is performed at the time of encoding an image, a current encoded image needs to be decoded and stored in order to be used as a reference picture. Therefore, the dequantizer 160 dequantizes the quantized coefficient, and the inverse transformer 170 inversely transforms the dequantized coefficient to output a reconstructed residual block. The adder 175 adds the reconstructed residual block to the prediction block to generate a reconstructed block.

The reconstructed block passes through the filter unit 180 and the filter unit 180 may apply at least one of a deblocking filter, a sample adaptive offset (SAO), and an adaptive loop filter (ALF) to a reconstructed block or a reconstructed picture. The filter unit 180 may also be called an adaptive in-loop filter. The deblocking filter may remove block distortion generated at an inter-block boundary. The SAO may add an appropriate offset value to a pixel value in order to compensate a coding error. The ALF may perform the filtering based on a comparison value between the reconstructed image and the original picture. The reconstructed block passing through the filter unit 180 may be stored in the reference picture buffer 190.

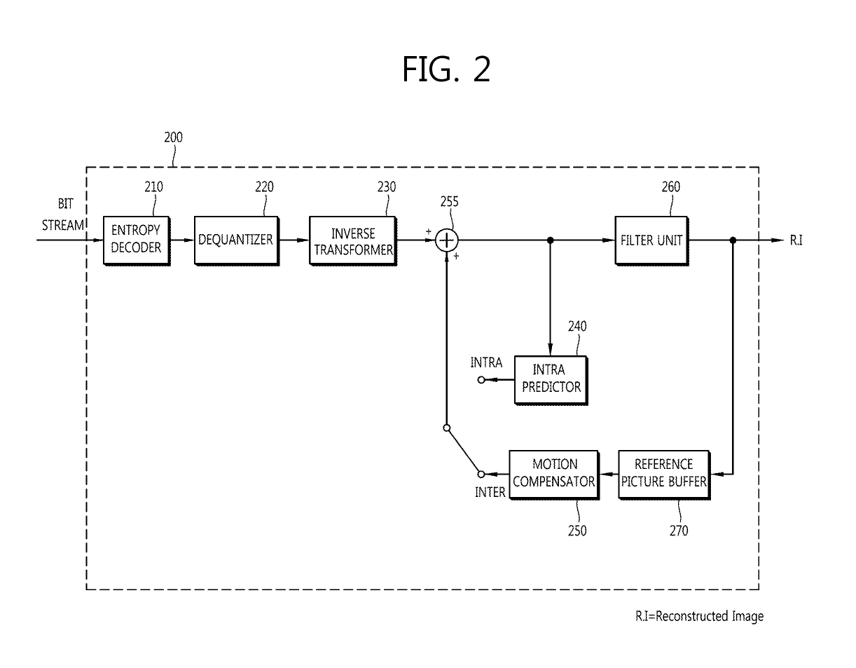

FIG. 2 is a block diagram showing a configuration of an apparatus of decoding an image according to another exemplary embodiment of the present invention.

Referring to FIG. 2, an apparatus 200 of decoding an image includes an entropy decoder 210, a dequantizer 220, an inverse transformer 230, an intra predictor 240, a motion compensator 250, a filter unit 260, and a reference picture buffer 270.

The apparatus 200 of decoding an image receives the bit stream output from the encoder to perform decoding in the intra mode or the inter mode and outputs the reconstructed image, that is, the recovered image. In the case of the intra mode, a prediction block is generated using an intra prediction method, and in the case of the inter mode, a prediction block is generated using an inter prediction method. The apparatus 200 of decoding an image obtains a residual block reconstructed from the received bit stream, generates the prediction block and then adds the residual block to the prediction block, thereby generating the reconstructed block, that is, the recovered block.

The entropy-decoding unit 210 entropy-decodes the input bit stream according to the probability distribution to output the quantized coefficient. The quantized coefficient is dequantized in the dequantizer 220 and inversely transformed in the reverse transformer 230. The quantized coefficient may be dequantized/inversely transformed, such that the reconstructed residual block is generated.

When the entropy decoding method is applied, a small number of bits are allocated to the symbols having high generation probability and a large number of bits are allocated to the symbols having low generation probability, such that the symbols are represented, thereby making it possible to reduce a size of the bit stream for each symbol. Therefore, the picture decoding compression performance may be improved through the entropy decoding method.

In the case of the intra prediction mode, the intra predictor 240 (or an inter predictor) performs spatial prediction using pixel values of previously decoded blocks adjacent to a current block to generate a prediction block.

In the case of the inter prediction mode, the motion compensator 250 performs the motion compensation using the motion vector and the reference picture stored in the reference picture buffer 270 to generate the prediction block.

The reconstructed residual block and the prediction block are added to each other through the adder 255 and the added block passes through the filter unit 260. The filter unit 260 may apply at least one of the deblocking filter, the SAO, and the ALF to the reconstructed block or the reconstructed picture. The filter unit 260 outputs the reconstructed image, that is, the recovered image. The reconstructed image may be stored in the reference picture buffer 270 to be used for the inter prediction.

As a method for improving prediction performance of the encoding/decoding apparatus, there are a method of increasing accuracy of an interpolation image and a method of predicting a difference signal. Here, the difference signal means a signal indicating a difference between an original image and a prediction image. In the present specification, the “difference signal” may be replaced by a “differential signal”, a “residual block”, or a “differential block” according to a context, which may be distinguished from each other by those skilled in the art without affecting the spirit and scope of the present invention.

As described above, hereinafter, a coding unit will be used as a terms indicating an encoding unit in an exemplary embodiments of the present invention for convenience of explanation. However, the coding unit may be a unit of performing decoding as well as encoding. Hereinafter, an inter prediction method using a plurality of reference pictures according to an exemplary embodiment of the present invention described with reference to FIGS. 1 to 9 may be implemented to be appropriate in functions of each modules described above with reference to FIGS. 1 and 2, and this encoder and decoder are included in the scope of the present invention. That is, a method of encoding an image and a method of decoding an image to be described below in an exemplary embodiment of the present invention may be performed in each component included in the image encoder and the image decoder described above with reference to FIGS. 1 and 2. The meaning of the component may include a software processing unit that may be performed through an algorithm as well as hardware meaning.

Hereinafter, although a method of performing prediction using two reference picture lists (L0 and L1 lists) will be mainly described in an exemplary embodiment of the present invention for convenience of explanation, prediction may be performed using two or more reference picture lists, which is included in the scope of the present invention.

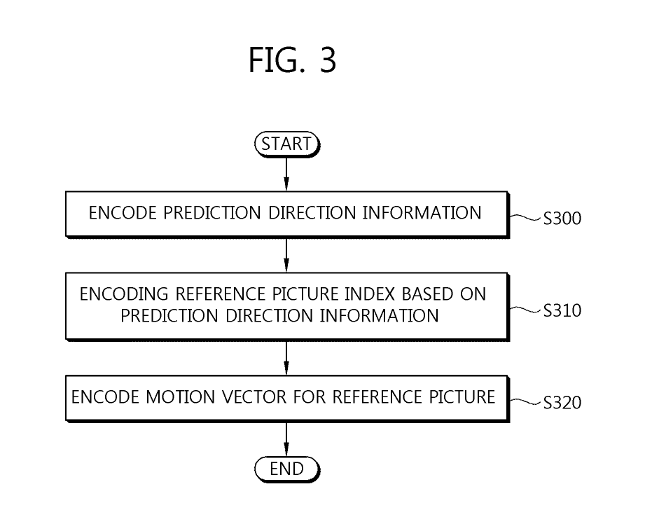

FIG. 3 is a flow chart showing a method of encoding an image using a plurality of reference pictures according to an exemplary embodiment of the present invention.

Referring to FIG. 3, prediction direction information is encoded (S300).

As a reference picture list for predicting an encoding target block for which prediction is to be performed using a plurality of reference pictures, L0 and L1 lists may be used. In the L0 list, a reference picture may be allocated with a smaller index number toward a forward direction in which the reference picture is close to a prediction target block, and the reference picture may be allocated with a larger index number toward a reverse direction in which the reference picture is distant from the prediction target block. To the contrary, in the L1 list, a reference picture may be allocated with a smaller index number toward a reverse direction in which the reference picture is close to a prediction target block, and the reference picture may be allocated with a larger index number toward a forward direction in which the reference picture is distant from the prediction target block. As a prediction method using two reference pictures, three methods may be used, and prediction direction information may be encoded as follows.

In a first prediction direction which is a two-direction prediction method, inter prediction may be performed on a current block using at least one reference picture among images belonging to the forward direction and at least one motion vector and least one reference picture among images belonging to the reverse direction and at least one motion vector.

In a second prediction direction which is a forward direction prediction method, inter prediction may be performed using a plurality of reference pictures among images belonging to the forward direction and a plurality of motion vectors corresponding thereto. Here, the plurality reference pictures may be same as each other.

In a third prediction direction which is a reverse direction prediction method, inter prediction may be performed using a plurality of reference pictures among images belonging to the reverse direction and a plurality of motion vectors corresponding thereto. Here, the plurality reference pictures may be same as each other.

That is, in S300, the prediction may be performed using three directions (the two-direction, the forward direction, the reverse-direction) according to which reference picture is used to perform prediction on a current prediction target block, and this prediction direction information may be encoded. The prediction direction information may be encoded using predetermined syntax element information, and the prediction direction information encoded using the syntax element may be decoded and used as the prediction direction information of the prediction target block in a decoding step.

A reference picture index is encoded based on the prediction direction information (S310).

In a method of encoding a reference picture index according to an exemplary embodiment of the present invention, different lists for encoding indices according to the prediction direction are used, thereby making it possible to allow a picture index number used to perform the inter prediction in the prediction target block to have a small number.

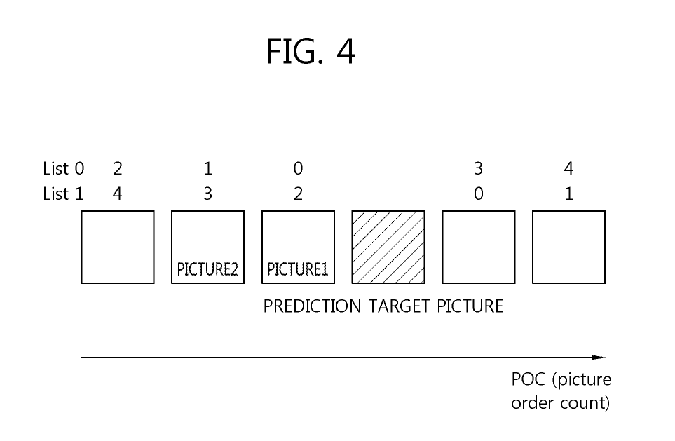

FIG. 4 is a conceptual diagram showing a method of selecting and encoding a reference picture index according to an exemplary embodiment of the present invention.

For example, in the case of a method of encoding a reference picture according to the related art, when the inter prediction is performed using a plurality of reference pictures (for example, picture 1 and picture 2), the picture 1 has used 0 which is a number indexed in a List0 list (L0 list) and the picture 2 has used 3 which is a number indexed in a List1 list (L1 list) to encode reference picture information used in a prediction target block. In the case of the L0 list, a reference picture may be allocated with a smaller index number toward a forward direction in which the reference picture is close to a prediction target block, and the reference picture may be allocated with a larger index number toward a reverse direction in which the reference picture is distant from the prediction target block. To the contrary, in the case of the L1 list, a reference picture may be allocated with a smaller index number toward a reverse direction in which the reference picture is close to a prediction target block, and the reference picture may be allocated with a larger index number toward a forward direction in which the reference picture is distant from the prediction target block. Therefore, in the case of performing the prediction using two reference pictures in the forward direction or the reverse direction (that is, the same direction), an index allocated to the reference picture is enlarged, such that a large number of bits are required in order to encode a large index, thereby reducing encoding efficiency. Therefore, in the method of encoding a reference picture index according to an exemplary embodiment of the present invention, reference picture information used in a prediction target block may be represented based on an index number having a small size by a method of calculating and using index information from a single list in the case of the forward direction or the reverse direction.

The picture index information used to perform the forward direction prediction may be encoded based on the picture index information of the L0 list, and the reference picture index may be encoded by different methods according to each prediction direction. For example, in the case of the first prediction direction, the reference picture present in the forward direction may be encoded based on the index information of the L0 list, and the reference picture present in the reverse direction may be encoded based on the index value included in the L1 list. Since the second prediction direction is the forward direction, the reference picture index information used by the prediction target block may be represented based on the L0 list index information of the reference pictures. Since the third prediction direction is the reverse direction, the reference picture index information used by the prediction target block may be represented based on the L1 list index information of the reference pictures. That is, in a method of representing reference picture index information according to an exemplary embodiment of the present invention, the picture is indexed using different lists of index information according to the prediction direction in order to encode the reference picture information used by the prediction target block using a smaller index.

A motion vector for a reference picture is encoded (S320).

In the case of the first prediction direction, the respective motion vectors for the reference pictures present in the forward and reverse directions of the prediction target picture may be encoded, in the case of the second prediction direction, the respective motion vectors for the pictures present in the forward direction of the prediction target picture may be encoded, and in the case of the third prediction direction, the respective motion vectors for the pictures present in the reverse direction of the prediction target picture may be encoded.

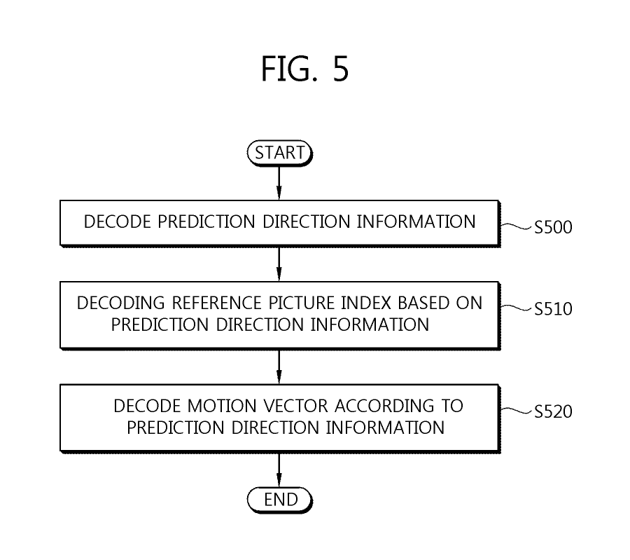

FIG. 5 is a flow chart showing a method of decoding an image using a plurality of reference pictures according to an exemplary embodiment of the present invention.

Referring to FIG. 5, prediction direction information is decoded (S500).

As a prediction direction, as described above, there may be three prediction directions, that is, a first prediction direction, a second prediction direction, and a third prediction direction, the encoded information indicating in which direction the prediction is performed may be decoded.

Reference picture index information is decoded according to the prediction direction information (S510).

Methods of calculating reference picture index information may be different according to the prediction direction information. For example, in the case of the first prediction direction, since the reference picture is used in the forward and reverse directions, at least one of the decoded index information indicates index information in the L0 list, and at least one of the decoded index information indicates index information in the L1 list. In the second prediction direction, a plurality of reference pictures in the forward direction are used, and all of the index information indicates the picture information indexed in the L0 list. In the third prediction direction, a plurality of reference pictures in the reverse direction are used, and all of the index information indicates the picture information indexed in the L1 list.

A motion vector is decoded according to the prediction direction information (S520).

As described above, since methods of indexing a reference picture may be different according to each prediction direction, after the motion vector is decoded on the reference pictures differently indexed according to each prediction direction, the decoded motion vector is applied, thereby making it possible to generate the prediction block, similar to the encoding step.

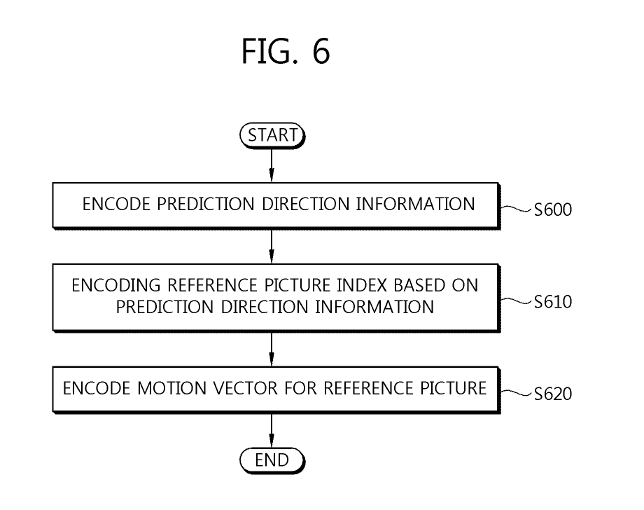

FIG. 6 is a flow chart showing a method of encoding an image using a plurality of reference pictures according to an exemplary embodiment of the present invention.

Referring to FIG. 6, prediction direction information is encoded (S600).

In FIGS. 3 to 5, the method of encoding reference picture index information of a prediction target block using two reference pictures has been disclosed. However, in the following exemplary embodiment of the present invention, a method of encoding reference picture index information of a prediction target block using a single reference picture will be disclosed. For example, blocks included in a picture B may be predicted using a plurality of motion vectors (motion vectors in each of two reference pictures or two motion vectors in a single reference picture) or be predicted using a single motion vector (a single motion vector in a single reference picture). Therefore, in addition to the prediction directions disclosed in FIGS. 3 to 5, two prediction methods which are a case of performing prediction in a forward direction and a case of performing prediction in a reverse direction may be additionally used.

In the case of the first and third prediction directions, prediction may be performed on a prediction target block using a fourth prediction direction in which inter prediction is performed using a single reference picture present in the forward direction and a single motion vector performing prediction from the corresponding reference picture and a fifth prediction direction in which inter prediction is performed using a single reference picture present in the reverse direction and a single motion vector performing prediction from the corresponding reference picture, in addition to the prediction directions disclosed in FIGS. 3 to 5. The prediction direction information may be represented by a syntax element such as inter_pred_idc, and values of each syntax element may be mapped to the prediction direction information used by the prediction target block and then encoded.

A reference picture index is encoded based on the prediction direction information (S610).

The reference picture index information may be encoded based on the prediction direction information calculated in S600. In the case of the first prediction direction in which the prediction is performed in the two directions, that is, the forward direction and reverse direction, a reference picture index value included in the L0 list and a reference picture index value included in the L1 list may be encoded. In the case of the second prediction direction in which the prediction is performed based on the plurality of pictures in the forward direction, a reference picture index value included in the L0 list may be encoded, and in the case of the third prediction direction in which the prediction is performed based on the plurality of pictures in the reverse direction, a reference picture index value included in the L1 list may be encoded. In the case of the fourth prediction direction, the reference picture index value included in the L0 list may be encoded to encode index information of the prediction target block, and in the case of the fifth prediction direction, the reference picture index value included in the L1 list may be encoded to encode index information of the prediction target block.

A motion vector for a reference picture is encoded (S620).

The motion vector for generating a prediction block of the prediction target block is encoded based on the reference picture determined according to the prediction direction.

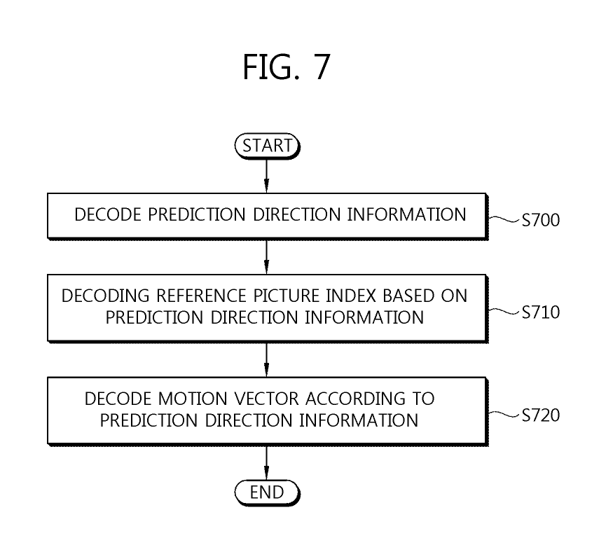

FIG. 7 is a flow chart showing a method of decoding an image using a plurality of reference pictures according to an exemplary embodiment of the present invention.

Referring to FIG. 7, prediction direction information is decoded (S700).

As the prediction direction, as described above with reference to FIG. 6, there may be first to fifth prediction directions, and the encoding information of the prediction target block may be decoded in order to find the reference picture information used by the prediction target block.

A reference picture index is decoded based on the prediction direction information (S710).

A picture indicated by a picture index used for prediction may be changed according to the prediction direction information. For example, in the case of the first prediction direction, the decoded index value may be the index value of the L0 list and the index value of the L1 list, in the case of the second and fourth prediction directions, the decoded index value may be the index value of the L0 list, and in the case of the third and fifth prediction directions, the decoded index value may be the index value of the L1 list.

A motion vector is decoded according to the prediction direction information (S720).

Reference pictures differently indexed according to each prediction direction may be determined, and motion vectors for generating prediction blocks of a decoding target blocks for the determined reference pictures may be decoded.

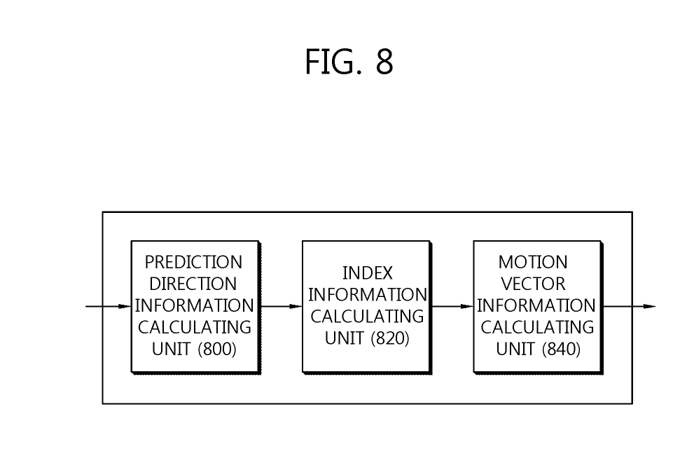

FIG. 8 is a conceptual diagram showing a portion of an apparatus of encoding an image according to an exemplary embodiment of the present invention.

Referring to FIG. 8, the predictor of the apparatus of encoding an image may include a prediction direction information calculating unit 800, an index information calculating unit 820, and a motion vector information calculating unit 840. The prediction direction information calculating 800 may determine any one of first to fifth prediction directions as a prediction direction of a prediction target block as described above with reference to FIGS. 3 to 6 to calculate corresponding information. The index information calculating unit 820 may calculate a reference picture index value for performing prediction on the prediction target block based on the prediction direction information. The motion vector information calculating unit 840 may encode motion vector information for predicting the prediction target block.

The calculated prediction direction information, index information, and motion vector information may be encoded in the entropy encoder.

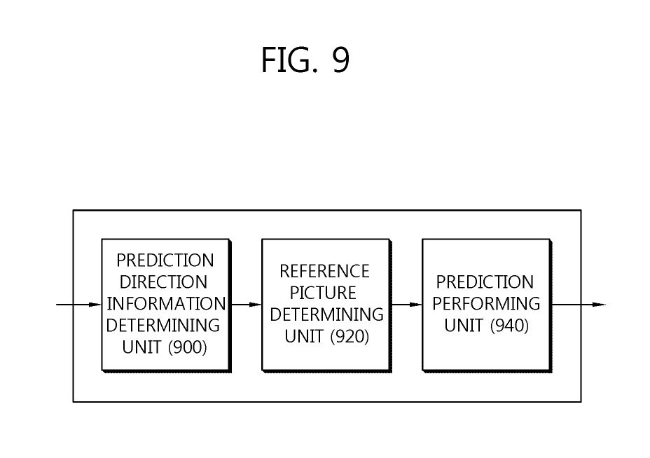

FIG. 9 is a conceptual diagram showing a portion of an apparatus of decoding an image according to an exemplary embodiment of the present invention.

Referring to FIG. 9, the predictor of the apparatus of decoding an image may include a prediction direction information determining unit 900, a reference picture determining unit 920, and a prediction performing unit 940. The prediction direction information determining unit 900 may determine which of the first to fifth prediction directions the direction for performing prediction for a current picture is based on the prediction direction information, the index information, and the motion vector information decoded in the entropy decoder. The reference picture determining unit 920 may determine which reference picture index value the prediction target block has based on the prediction direction information. The prediction performing unit 940 may perform the prediction based on the decoded motion vector information and the index information calculated in the reference picture determining unit 920.

Hereinabove, although the present invention have been described with reference to the exemplary embodiments thereof, those skilled in the art will appreciate that various modifications, additions and substitutions are possible, without departing from the scope and spirit of the invention as disclosed in the accompanying claims.

1. A method of decoding an image, the method comprising:
decoding prediction direction information; and
decoding reference picture index information based on the prediction direction information.

2. The method of claim 1, wherein the prediction direction information includes a first prediction direction in which a prediction target block is predicted based on at least one of pictures present in a reverse direction of a prediction target picture and at least one of pictures present in a forward direction of the prediction target picture, a second direction in which the prediction target block is predicted based on ones of the pictures present in the forward direction of the prediction target picture, and a third direction in which the prediction target block is predicted based on ones of the pictures present in the reverse direction of the prediction target picture.

3. The method of claim 2, wherein the prediction direction information further includes a fourth direction in which the prediction target block is predicted based on one of the pictures present in the forward direction of the prediction target picture and a fifth direction in which the prediction target block is predicted based on one of the pictures present in the reverse direction of the prediction target picture.

4. The method of claim 1, wherein the decoding of the reference picture index information based on the prediction direction information includes decoding at least one picture index in a forward direction of a prediction target picture and decoding at least one picture index in a reverse direction of the prediction target picture in the case in which a prediction target block is a first direction, decoding a plurality of picture indices in the forward direction of the prediction target picture in the case in which the prediction target block is a second direction, and decoding a plurality of picture indices in the reverse direction of the prediction target picture in the case in which the prediction target block is a third direction.

5. The method of claim 4, wherein the decoding of the reference picture index information based on the prediction direction information further includes decoding one picture index in the forward direction of the prediction target picture in the case in which the prediction target block is a fourth direction and decoding one picture index in the reverse direction of the prediction target picture in the case in which the prediction target block is a fifth direction.

6. The method of claim 1, further comprising decoding motion vector information.

7. The method of claim 1, wherein the prediction direction information is information encoded as syntax element information.

8. An apparatus of decoding an image, the apparatus comprising:
a prediction direction information determining unit determining prediction direction information; and
a reference picture determining unit determining index information of a picture predicted based on the prediction direction information.

9. The apparatus of claim 8, wherein the prediction direction information includes a first prediction direction in which a prediction target block is predicted based on at least one of pictures present in a reverse direction of a prediction target picture and at least one of pictures present in a forward direction of the prediction target picture, a second direction in which the prediction target block is predicted based on ones of the pictures present in the forward direction of the prediction target picture, and a third direction in which the prediction target block is predicted based on ones of the pictures present in the reverse direction of the prediction target picture.

10. The apparatus of claim 9, wherein the prediction direction information further includes a fourth direction in which the prediction target block is predicted based on one of the pictures present in the forward direction of the prediction target picture and a fifth direction in which the prediction target block is predicted based on one of the pictures present in the reverse direction of the prediction target picture.

11. The apparatus of claim 8, wherein the decoding of the reference picture index information based on the prediction direction information includes decoding at least one picture index in a forward direction of a prediction target picture and decoding at least one picture index in a reverse direction of the prediction target picture in the case in which a prediction target block is a first direction, decoding a plurality of picture indices in the forward direction of the prediction target picture in the case in which the prediction target block is a second direction, and decoding a plurality of picture indices in the reverse direction of the prediction target picture in the case in which the prediction target block is a third direction.

12. The apparatus of claim 11, wherein the decoding of the reference picture index information based on the prediction direction information further includes decoding one picture index in the forward direction of the prediction target picture in the case in which the prediction target block is a fourth direction and decoding one picture index in the reverse direction of the prediction target picture in the case in which the prediction target block is a fifth direction.

13. The apparatus of claim 8, further comprising a prediction performing unit decoding motion vector information to perform prediction.
